(19) United States
(12) Patent Application Publication
(10) Pub. No.: US 2025/0310937 A1
(43) Pub. Date: Oct. 2, 2025

(54) EFFICIENT SEMI-STATIC HARQ CODEBOOK OPERATION IN TELECOMMUNICATION SYSTEMS

(71) Applicant: Nokia Technologies Oy, Espoo (FI)

(72) Inventors: Gayatri Virupaxayya EMMIMATH, Espoo (FI); Anand BEDEKAR, Espoo (FI)

(21) Appl. No.: 18/872,969

(22) PCT Filed: Jun. 16, 2022
(86) PCT No.: PCT/US2022/033776

§ 371 Date: Dec. 9, 2024

(51) Int. Cl. H04W 72/0446; H04W 72/21

(52) U.S. Cl. CPC H04W 72/0446; H04W 72/21

(57) ABSTRACT

In a system, apparatus, method, and non-transitory computer readable medium, a UE device may be caused to, obtain a plurality of subsets of acknowledgement/negative acknowledgement (AN) offset values associated with at least one desired transmission frame from at least one RAN node, the desired transmission frame including at least one DL slot and at least one UL slot, receive DL data from the at least one RAN node in the at least one DL slot, determine a number of AN bits to transmit to the at least one RAN node for at least one UL slot based on the plurality of subsets of AN offset values, and transmit AN indications to the at least one RAN node in the at least one UL slot based on the received DL data and the determined number of AN bits for the at least one UL slot.

### BACKGROUND

### Field

Various example embodiments relate to methods, apparatuses, systems, and/or non-transitory computer readable media for providing more efficient semi-static hybrid automatic repeat request (HARQ) codebook operation in telecommunication systems, thereby improving uplink coverage for user equipment devices by reducing and/or optimizing the number of acknowledgement/negative acknowledgement (AN) bits transmitted by the user equipment devices.

### Description of the Related Art

A 5^{th} generation mobile network (5G) standard, referred to as 5G New Radio (NR), is being developed to provide higher capacity, higher reliability, and lower latency communications than the 4G long term evolution (LTE) standard.

The 5G NR standard provides semi-static or dynamic codebooks for performing HARQ AN reporting by user equipment (UE) devices, e.g., the UE device transmitting acknowledgement (ACK) or negative acknowledgment (NACK) bits during a specific uplink (UL) slot, the ACK or NACK bit corresponding to the receipt or non-receipt of data from one or more radio access network (RAN) nodes during one or more downlink (DL) slots.

### SUMMARY

At least one example embodiment relates to a user equipment (UE) device.

In at least one example embodiment, the UE device may include a memory storing computer readable instructions, and processing circuitry configured to execute the computer readable instructions to cause the device to, obtain a plurality of subsets of acknowledgement/negative acknowledgement (AN) offset values associated with at least one desired transmission frame from at least one radio access network (RAN) node, the desired transmission frame including at least one downlink (DL) slot and at least one uplink (UL) slot, receive DL data from the at least one RAN node in the at least one DL slot of the desired transmission frame, determine a number of AN bits to transmit to the at least one RAN node for at least one UL slot of the desired transmission frame based on the plurality of subsets of AN offset values, and transmit AN indications to the at least one RAN node in the at least one UL slot based on the received DL data and the determined number of AN bits for the at least one UL slot.

Some example embodiments provide that the obtaining the plurality of subsets of AN offset values further includes receiving the plurality of subsets via a radio resource control (RRC) message from the at least one RAN node, the RRC message including UL slot mapping information associated with at least one subset of the plurality of subsets to the at least one UL slot.

Some example embodiments provide that the at least one UL slot is a plurality of UL slots, and the UL slot mapping information includes UL slot mapping information indicating a mapping of each of the plurality of UL slots to a subset of the plurality of subsets.

Some example embodiments provide that the at least one DL slot is a plurality of DL slots, and the device is further caused to, determine which DL slot of the plurality of DL slots maps to the at least one UL slot based on the UL slot mapping information associated with the at least one UL slot, and generate the AN indications for the plurality of DL slots based on a status of the received DL data associated with each DL slot of the plurality of DL slots.

Some example embodiments provide that the device is further caused to, receive a plurality of updated subsets of AN offset values from the at least one RAN node for the at least one UL slot of the desired transmission frame, each UL slot of the at least one UL slot corresponding to at least one component carrier (CC) of a plurality of CCs, receive new DL data from the at least one RAN node in the at least one CC from the at least one RAN node, determine an updated number of AN bits to transmit to the at least one RAN node for each UL slot of the at least one UL slot based on the plurality of updated subsets of AN offset values, and transmit updated AN indications to the at least one RAN node in the at least one UL slot based on the received new DL data and the determined updated number of AN bits for the at least one UL slot.

Some example embodiments provide that the at least one RAN node includes at least a first RAN node and a second RAN node, and each of the first RAN node and the second RAN node are configured to communicate with the UE device using a different CC of the plurality of CCs.

Some example embodiments provide that the device is further caused to, receive a first updated subset of AN offset values for each UL slot corresponding to a first CC from the first RAN node, and receive a second updated subset of AN offset values for each UL slot corresponding to a second CC from the first RAN node.

Some example embodiments provide that the device is further caused to, receive downlink control information (DCI) for DL grant from the at least one RAN node, the DCI including an indication of the updated subset of AN offset values to be used for a desired UL slot, receive new DL data from the at least one RAN node in the at least one DL slot of the desired transmission frame, determine an updated number of AN bits to transmit to the at least one RAN node in the desired UL slot based on the updated subsets of AN offset values, and transmit updated AN indications to the at least one RAN node in the desired UL slot based on the received new DL data and the determined updated number of AN bits for the desired UL slot.

At least one example embodiment relates to a radio access network (RAN) node.

In at least one example embodiment, the RAN node may include a memory storing computer readable instructions, and processing circuitry configured to execute the computer readable instructions to cause the node to, determine a set of acknowledgement/negative acknowledgement (AN) offset values associated with at least one desired transmission frame, the desired transmission frame including at least one downlink (DL) slot and at least one uplink (UL) slot, determine a subset of AN offset values from the set of AN offset values for at least one UL slot of the desired transmission frame, and transmit the at least one subset to a user equipment (UE) device.

Some example embodiments provide that the node is further caused to, generate a radio resource control (RRC) message, the RRC message including the at least one subset and UL slot mapping information associated with the at least one subset, and the transmitting the at least one subset includes transmitting the RRC message to the UE device.

Some example embodiments provide that the node is further caused to, receive at least one AN indication from the UE device based on the determined at least one subset.

Some example embodiments provide that the at least one UL slot is a plurality of UL slots, and the determining the subset of AN offset values includes, determining a plurality of subsets of AN offset values from the set of AN offset values, and determining UL slot mapping information, the UL slot mapping information indicating a mapping for each of the UL slots of the plurality of UL slots to at least one subset of the plurality of subsets of AN offset values.

Some example embodiments provide that the at least one DL slot is a plurality of DL slots, and the determining the subset of AN offset values includes determining which DL slot of the plurality of DL slots maps to the at least one UL slot.

Some example embodiments provide that the node is further caused to, determine whether to perform carrier aggregation for the UE device, the determining including determining a plurality of component carriers (CCs) to use with the UE device, determine updated subsets of AN offset values from the set of AN offset values for each of the at least one UL slot, each of the at least one UL slot corresponding to at least one CC of the plurality of determined CCs, determine updated UL slot mapping information, the updated UL slot mapping information indicating an updated mapping for each UL slot of the at least one UL slot to the updated subsets of the AN offset values, for each of the CCs for the UE device, and transmit the updated subsets and the updated UL slot mapping information to the UE device.

Some example embodiments provide that the node is further caused to, receive DL data for transmission to the UE device, determine at least one DL slot in which the received DL data is to be transmitted to the UE device, determine at least one UL slot for the UE device to transmit an AN indication corresponding to the determined at least one DL slot, determine the subset of AN offset values to be used for the determined at least one UL slot, generate downlink control information (DCI) for DL grant for the UE device, the generated DCI including an indication of the determined subset of AN offset values to be used for the determined UL slot, and transmit the DCI to the UE device.

At least one example embodiment relates to a method of operating a user equipment (UE) device.

In at least one example embodiment, the method may include, obtaining a plurality of subsets of acknowledgement/negative acknowledgement (AN) offset values associated with at least one desired transmission frame from at least one radio access network (RAN) node, the desired transmission frame including at least one downlink (DL) slot and at least one uplink (UL) slot, receiving DL data from the at least one RAN node in the at least one DL slot of the desired transmission frame, determining a number of AN bits to transmit to the at least one RAN node for at least one UL slot of the desired transmission frame based on the plurality of subsets of AN offset values, and transmitting AN indications to the at least one RAN node in the at least one UL slot based on the received DL data and the determined number of AN bits for the at least one UL slot.

Some example embodiments provide that the obtaining the plurality of subsets of AN offset values further includes, receiving the plurality of subsets via a radio resource control (RRC) message from the at least one RAN node, the RRC message including UL slot mapping information associated with at least one subset of the plurality of subsets to the at least one UL slot.

Some example embodiments provide that the at least one UL slot is a plurality of UL slots, and the UL slot mapping information includes UL slot mapping information indicating a mapping of each of the plurality of UL slots to a subset of the plurality of subsets.

Some example embodiments provide that the at least one DL slot is a plurality of DL slots, and the method further comprises, determining which DL slot of the plurality of DL slots maps to the at least one UL slot based on the UL slot mapping information associated with the at least on UL slot, and generating the AN indications for the plurality of DL slots based on a status of the received DL data associated with each DL slot of the plurality of DL slots.

Some example embodiments provide that the method further comprises, receiving a plurality of updated subsets of AN offset values from the at least one RAN node for the at least one UL slot of the desired transmission frame, each UL slot of the at least one UL slot corresponding to at least one component carrier (CC) of a plurality of CCs, receiving new DL data from the at least one RAN node in the at least one CC from the at least one RAN node, determining an updated number of AN bits to transmit to the at least one RAN node for each UL slot of the at least one UL slot based on the plurality of updated subsets of AN offset values, and transmitting updated AN indications to the at least one RAN node in the at least one UL slot based on the received new DL data and the determined updated number of AN bits for the at least one UL slot.

Some example embodiments provide that the at least one RAN node includes at least a first RAN node and a second RAN node, and each of the first RAN node and the second RAN node are configured to communicate with the UE device using a different CC of the plurality of CCs.

Some example embodiments provide that the method further comprises, receiving a first updated subset of AN offset values for each UL slot corresponding to a first CC from the first RAN node, and receiving a second updated subset of AN offset values for each UL slot corresponding to a second CC from the first RAN node.

Some example embodiments provide that the method further comprises, receiving downlink control information (DCI) for DL grant from the at least one RAN node, the DCI including an indication of the updated subset of AN offset values to be used for a desired UL slot, receiving new DL data from the at least one RAN node in the at least one DL slot of the desired transmission frame, determining an updated number of AN bits to transmit to the at least one RAN node the desired UL slot based on the updated subsets of AN offset values, and transmitting updated AN indications to the at least one RAN node in the desired UL slot based on the received new DL data and the determined updated number of AN bits for the desired UL slot.

At least one example embodiment relates to a method of operating a radio access network (RAN) node.

In at least one example embodiment, the method may include, determining a set of acknowledgement/negative acknowledgement (AN) offset values associated with at least one desired transmission frame, the desired transmission frame including at least one downlink (DL) slot and at least one uplink (UL) slot, determining a subset of AN offset values from the set of AN offset values for each UL slot of the desired transmission frame, and transmitting the at least one subset to a user equipment (UE) device.

Some example embodiments provide that the method further comprises, generating a radio resource control (RRC) message, the RRC message including the at least one subset and UL slot mapping information associated with the at least one subset, and wherein the transmitting the at least one subset includes transmitting the RRC message to the UE device.

Some example embodiments provide that the method further comprises, receiving at least one AN indication from the UE device based on the determined at least one subset.

Some example embodiments provide that the at least one UL slot is a plurality of UL slots, and the determining the subset of AN offset values includes, determining a plurality of subsets of AN offset values from the set of AN offset values, and determining UL slot mapping information, the UL slot mapping information indicating a mapping for each of the UL slot of the plurality of UL slots to the subset of the AN offset values from the set of AN offset values.

Some example embodiments provide that the at least one DL slot is a plurality of DL slots, and the determining the subset of AN offset values includes determining which DL slot of the plurality of DL slots maps to the at least one UL slot.

Some example embodiments provide that the method further comprises, determining whether to perform carrier aggregation for the UE device, the determining including determining a plurality of component carriers (CCs) to use with the UE device, determining updated subsets of AN offset values from the set of AN offset values for each of the at least one UL slot, each of the at least one UL slot corresponding to at least one CC of the plurality of determined CCs, determining updated UL slot mapping information, the updated UL slot mapping information indicating an updated mapping for each of the UL slot of the plurality of UL slots to the updated subsets of the AN offset values from the set of AN offset values, for each of the CCs for the UE device, and transmitting the updated subsets and the updated UL slot mapping information to the UE device.

Some example embodiments provide that the method further comprises, receiving DL data for transmission to the UE device, determining at least one DL slot in which the received DL data is to be transmitted to the UE device, determining at least one UL slot for the UE device to transmit an AN indication corresponding to the determined at least one DL slot, determining the subset of AN offset values to be used for the determined at least one UL slot, generating a downlink control information (DCI) for DL grant for the UE device, the generated DCI including an indication of the determined subset of AN offset values to be used for the determined UL slot, and transmitting the DCI to the UE device.

At least one example embodiment relates to a user equipment (UE) device.

In at least one example embodiment, the UE device may include means for, obtaining a plurality of subsets of acknowledgement/negative acknowledgement (AN) offset values associated with at least one desired transmission frame from at least one radio access network (RAN) node, the desired transmission frame including at least one downlink (DL) slot and at least one uplink (UL) slot, receiving DL data from the at least one RAN node in the at least one DL slot of the desired transmission frame, determining a number of AN bits to transmit to the at least one RAN node for at least one UL slot of the desired transmission frame based on the plurality of subsets of AN offset values, and transmitting AN indications to the at least one RAN node in the at least one UL slot based on the received DL data and the determined number of AN bits for the at least one UL slot.

Some example embodiments provide that the obtaining the plurality of subsets of AN offset values further includes receiving the plurality of subsets via a radio resource control (RRC) message from the at least one RAN node, the RRC message including UL slot mapping information associated with at least one subset of the plurality of subsets to the at least one UL slot.

Some example embodiments provide that the at least one UL slot is a plurality of UL slots, and the UL slot mapping information includes UL slot mapping information indicating a mapping of each of the plurality of UL slots to a subset of the plurality of subsets.

Some example embodiments provide that the at least one DL slot is a plurality of DL slots, and the device further includes means for, determining which DL slot of the plurality of DL slots maps to the at least one UL slot based on the UL slot mapping information associated with the at least one UL slot, and generating the AN indications for the plurality of DL slots based on a status of the received DL data associated with each DL slot of the plurality of DL slots.

Some example embodiments provide that the device further includes means for, receiving a plurality of updated subsets of AN offset values from the at least one RAN node for the at least one UL slot of the desired transmission frame, each UL slot of the at least one UL slot corresponding to at least one component carrier (CC) of a plurality of CCs, receiving new DL data from the at least one RAN node in the at least one CC from the at least one RAN node, determining an updated number of AN bits to transmit to the at least one RAN node for each UL slot of the at least one UL slot based on the plurality of updated subsets of AN offset values, and transmitting updated AN indications to the at least one RAN node in the at least one UL slot based on the received new DL data and the determined updated number of AN bits for the at least one UL slot.

Some example embodiments provide that the at least one RAN node includes at least a first RAN node and a second RAN node, and each of the first RAN node and the second RAN node are configured to communicate with the UE device using a different CC of the plurality of CCs.

Some example embodiments provide that the device further includes means for, receiving a first updated subset of AN offset values for each UL slot corresponding to a first CC from the first RAN node, and receiving a second updated subset of AN offset values for each UL slot corresponding to a second CC from the first RAN node.

Some example embodiments provide that the device further includes means for, receiving downlink control information (DCI) for DL grant from the at least one RAN node, the DCI including an indication of the updated subset of AN offset values to be used for a desired UL slot, receiving new DL data from the at least one RAN node in the at least one DL slot of the desired transmission frame, determining an updated number of AN bits to transmit to the at least one RAN node in the desired UL slot based on the updated subsets of AN offset values, and transmitting updated AN indications to the at least one RAN node in the desired UL slot based on the received new DL data and the determined updated number of AN bits for the desired UL slot.

At least one example embodiment relates to a radio access network (RAN) node.

In at least one example embodiment, the RAN node may include means for, determining a set of acknowledgement/negative acknowledgement (AN) offset values associated with at least one desired transmission frame, the desired transmission frame including at least one downlink (DL) slot and at least one uplink (UL) slot, determining a subset of AN offset values from the set of AN offset values for at least one UL slot of the desired transmission frame, and transmitting the at least one subset to a user equipment (UE) device.

Some example embodiments provide that the node further includes means for, generating a radio resource control (RRC) message, the RRC message including the at least one subset and UL slot mapping information associated with the at least one subset, and the transmitting the at least one subset includes transmitting the RRC message to the UE device.

Some example embodiments provide that the node further includes means for, receiving at least one AN indication from the UE device based on the determined at least one subset.

Some example embodiments provide that the at least one UL slot is a plurality of UL slots, and the determining the subset of AN offset values includes, determining a plurality of subsets of AN offset values from the set of AN offset values, and determining UL slot mapping information, the UL slot mapping information indicating a mapping for each of the UL slots of the plurality of UL slots to at least one subset of the plurality of subsets of AN offset values.

Some example embodiments provide that the at least one DL slot is a plurality of DL slots, and the determining the subset of AN offset values includes determining which DL slot of the plurality of DL slots maps to the at least one UL slot.

Some example embodiments provide that the node further includes means for, determining whether to perform carrier aggregation for the UE device, the determining including determining a plurality of component carriers (CCs) to use with the UE device, determining updated subsets of AN offset values from the set of AN offset values for each of the at least one UL slot, each of the at least one UL slot corresponding to at least one CC of the plurality of determined CCs, determining updated UL slot mapping information, the updated UL slot mapping information indicating an updated mapping for each UL slot of the at least one UL slot to the updated subsets of the AN offset values, for each of the CCs for the UE device, and transmitting the updated subsets and the updated UL slot mapping information to the UE device.

Some example embodiments provide that the node further includes means for, receiving DL data for transmission to the UE device, determining at least one DL slot in which the received DL data is to be transmitted to the UE device, determining at least one UL slot for the UE device to transmit an AN indication corresponding to the determined at least one DL slot, determine the subset of AN offset values to be used for the determined at least one UL slot, generating downlink control information (DCI) for DL grant for the UE device, the generated DCI including an indication of the determined subset of AN offset values to be used for the determined UL slot, and transmitting the DCI to the UE device.

### BRIEF DESCRIPTION OF THE DRAWINGS

The accompanying drawings, which are incorporated in and constitute a part of the specification, illustrate one or more example embodiments and, together with the description, explain these example embodiments. In the drawings:

FIG. 1 illustrates a wireless communication system according to at least one example embodiment;

FIG. 2 illustrates a block diagram of an example RAN node according to at least one example embodiment;

FIG. 3 illustrates a block diagram of an example UE device according to at least one example embodiment;

FIGS. 4-6 illustrate example transmission diagrams for performing improved AN reporting using a semi-static HARQ codebook according to some example embodiments;

FIG. 7A is an example diagram illustrating a set of AN offset values for use with a conventional semi-static HARQ codebook according to the related art; and

FIG. 7B is an example diagram illustrating a set of AN offset values and a plurality of subsets of AN offset values according to at least one example embodiment.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing the example embodiments. The example embodiments may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of the example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware circuitry and/or software, firmware, middleware, microcode, hardware description languages, etc., in combination with hardware (e.g., software executed by hardware, etc.). When implemented in software, firmware, middleware or microcode, the program code or code segments to perform the desired tasks may be stored in a machine or computer readable medium such as a non-transitory computer storage medium, and loaded onto one or more processors to perform the desired tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory(ies) that work together to cause an apparatus, such as a mobile phone or server, to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

While the various example embodiments of the present disclosure are discussed in connection with the 5G wireless communication standard for the sake of clarity and convenience, the example embodiments are not limited thereto, and one of ordinary skill in the art would recognize the example embodiments may be applicable to other wireless communication standards, such as the 4G standard, a Wi-Fi standard, a future 6G standard, a future 7G standard, etc.

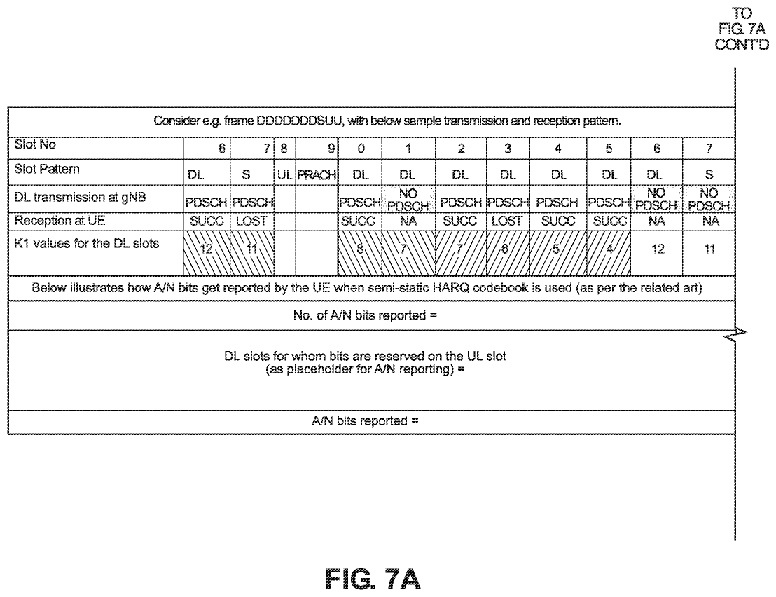

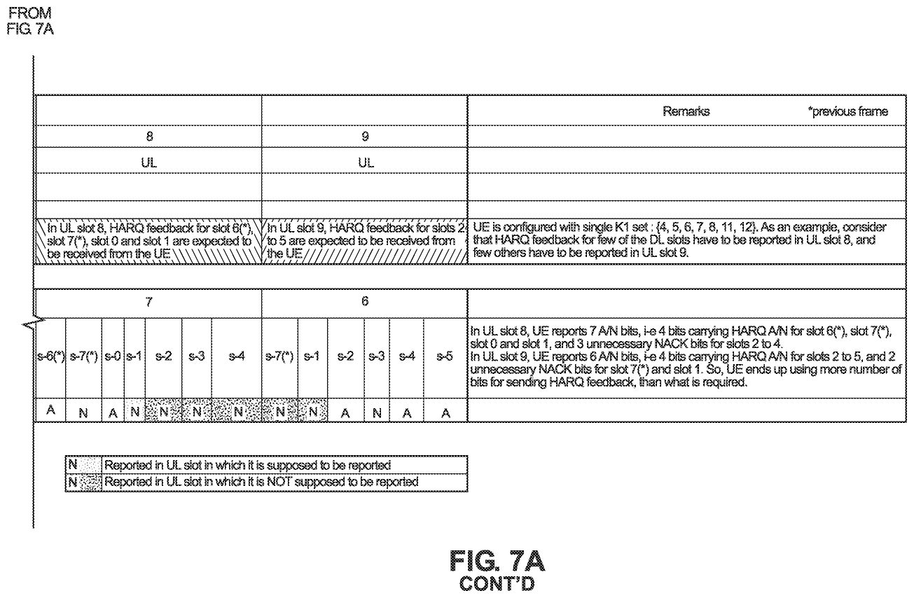

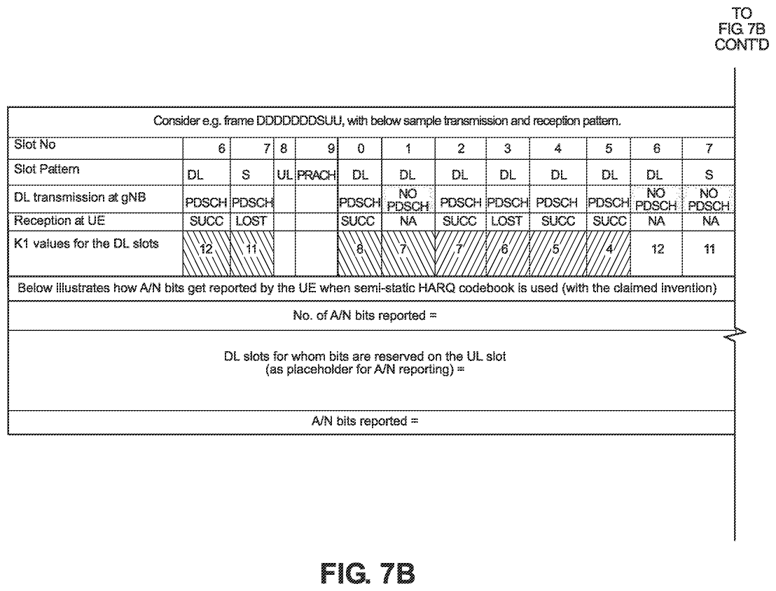

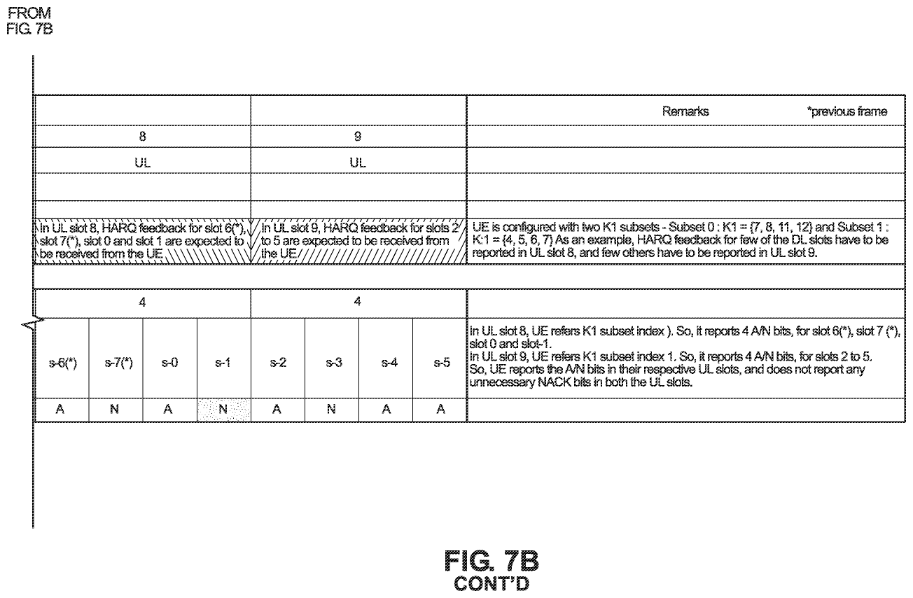

Various example embodiments are directed towards improvements to HARQ AN reporting using semi-static codebook by reducing and/or optimizing the total number of AN bits reported in a UL slot by a UE device. As currently defined in the 5G standard, and as shown in FIG. 7A which illustrates a set of AN offset values for use with a conventional semi-static HARQ codebook according to the related art, when a conventional semi-static codebook is used, the network and/or RAN node defines a single set of K1 values (e.g., a set of AN offset values, etc.) for use by the UE device, e.g., K1 values {4, 5, 6, 7, 8, 11, and 12} as shown in FIG. 7A. In the semi-static codebook as currently defined in the 3GPP standard, the set of K1 values defines the offset values of DL slots for which ack/nack bits will be reported in a desired UL slot in at least one desired transmission frame, for each CC assigned to the UE device. Each of the AN bits indicates the ACK or NACK of PDSCH data received in the preceding DL slots to the desired UL slot at the offsets indicated by the set of K1 values, or in other words, if the set of K1 values contains 8 distinct values, e.g., values 1 through 8, then the UE will report ACK/NACK of the preceding 8 DL slots to the desired UL slot N (e.g., report ACK/NACK for each of the DL slots: N-8, N-7, N-6, N-5, N-4, N-3, N-2, and N-1), which results in reduced implementation complexity and/or reduced latency in comparison to AN reporting using a dynamic codebook, due to the pre-definition of the number of AN bits to upload in each UL slot. However, usage of the conventional semi-static codebook for AN reporting in the related art may result in inefficient network resource usage and/or increased UL transmission times because the UE device will always transmit K AN bits if there are K distinct values indicated in the set of K1 values (e.g., if K=8 distinct values, then approximately 8 AN bits in single-carrier operation, approximately 16 AN bits for dual carrier operation, etc.) even if the gNB and/or RAN node did not transmit anything in the corresponding 8 DL slots and/or even if the desired transmission frame does not require AN reporting for every one of the 8 DL slots of each CC assigned to the UE device. For example, as shown in FIG. 7A, the UE device is scheduled with a transmission frame including 10 slots (e.g., slots 0 to 9), with slot 0 to slot 6 being scheduled as DL slots, slot 7 scheduled as a S slot, and slots 8 and 9 scheduled as UL slots, and HARQ feedback for DL slots 6 and 7 of the previous transmission frame, and DL slot 0 and slot 1 of the current transmission frame is expected to be received on UL slot 8, and HARQ feedback for DL slots 2 and 5 of the current transmission frame is expected to be received on UL slot 9. Further, assuming the UE device is configured to report AN in both UL slots, the UE device will report 7 AN bits in the first UL slot (e.g., slot 8), which includes 4 bits carrying HARQ A/N feedback corresponding to slots 6 and 7 of the previous transmission frame and slots 0 and 1 of the current transmission frame, and 3 unnecessary NACK bits for slots 2 to 4, based on the defined set of K1 values, and the UE device will report 6 AN bits in the second UL slot (e.g., slot 9), which includes 2 unnecessary NACK bits corresponding to slot 7 of the previous transmission frame and slot 1 of the current transmission frame, and 4 bits carrying HARQ A/N feedback corresponding to slots 2 to 5 of current transmission frame, based on the defined set of K1 values.

Accordingly, one or more example embodiments provide an improvement to conventional semi-static codebook HARQ AN reporting by allowing the network and/or the RAN node to intelligently determine at least one subset of K1 values (e.g., a subset of AN offset values, etc.) to assign to one or more UL slot(s) included in a desired transmission frame scheduled for a UE device, which may result in a reduced number of AN bits transmitted by the UE device to the network. Additionally, the one or more example embodiments provide an improvement over dynamic codebook HARQ AN reporting by using a desired and/or predefined set of K1 values and subsets of K1 values, thereby reducing the implementation complexity of the dynamic codebook AN reporting scheme, and/or reducing the latency for reporting AN to the network in comparison to dynamic codebook, especially with regards to carrier aggregation (CA), etc.

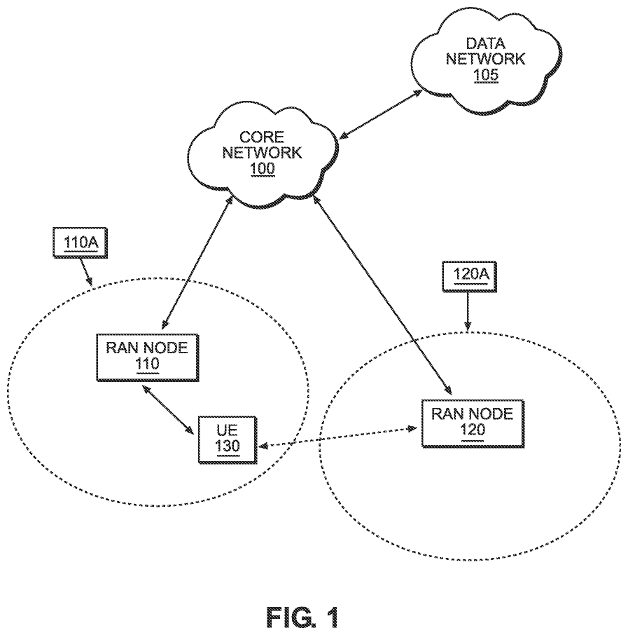

FIG. 1 illustrates a wireless communication system according to at least one example embodiment. As shown in FIG. 1, a wireless communication system includes a core network 100, a Data Network 105, a first radio access network (RAN) node 110, a second RAN node 120, and a first user equipment device (e.g., UE device or UE, etc.) 130, etc., but the example embodiments are not limited thereto, and for example, may include a greater or lesser number of constituent elements. For example, the wireless communication system may include three or more RAN nodes, two or more UE devices, additional base stations, servers, routers, access points, gateways, etc.

The RAN node 110, the RAN node 120 and/or the UE device 130 may be connected over a wireless network, such as a cellular wireless access network (e.g., a 3G wireless access network, a 4G-Long Term Evolution (LTE) network, a 5G-New Radio (e.g., 5G) wireless network, a 6G wireless network, a WiFi network, etc.). The wireless network may include a core network 100 and/or a Data Network 105. The RAN node 110 and the RAN node 120 may connect to other RAN nodes (not shown), as well as to the core network 100 and/or the Data Network 105, over a wired and/or wireless network. The core network 100 and the Data Network 105 may connect to each other over a wired and/or wireless network. The Data Network 105 may refer to the Internet, an intranet, a wide area network, etc.

According to some example embodiments, the RAN nodes 110, 120 may act as a relay node (e.g., an integrated access and backhaul (IAB) node) and may communicate with the UE device 130, etc., in combination with at least one base station (and/or access point (AP), router, etc.) (not shown) of the same or a different radio access technology (e.g., WiFi, etc.).

The UE device 130 may be any one of, but not limited to, a mobile device, a smartphone, a tablet, a desktop computer, a laptop computer, a wearable device, an Internet of Things (IoT) device, a sensor (e.g., thermometers, humidity sensors, pressure sensors, motion sensors, accelerometers, etc.), actuators, robotic devices, robotics, drones, connected medical devices, eHealth devices, smart city related devices, a security camera, autonomous devices (e.g., autonomous cars, etc.), and/or any other type of stationary or portable device capable of operating according to, for example, the 5G NR communication standard, and/or other wireless communication standard(s). The UE device 130 may be configurable to transmit and/or receive data in accordance to strict latency, reliability, and/or accuracy requirements, such as URLLC communications, TSC communications, etc., but the example embodiments are not limited thereto.

The wireless communication system further includes a plurality of transmission/reception points (TRPs) (e.g., a base station, a wireless access point, etc.), such as RAN node 110, RAN node 120, etc. The RAN nodes 110, 120, etc., may operate according to an underlying cellular and/or wireless radio access technology (RAT), such as 5G NR, LTE, Wi-Fi, etc. For example, the RAN nodes 110, 120, etc., may be a 5G gNB node, a LTE eNB node, or a LTE ng-eNB node, etc., but the example embodiments are not limited thereto. The RAN nodes 110, 120, etc. may provide wireless network services to one or more UE devices within one or more cells (e.g., cell service areas, broadcast areas, serving areas, coverage areas, etc.) surrounding the respective physical location of the RAN node. As shown in FIG. 1, the RAN node 110 may provide cell 110A and RAN node 120 may provide cell 120A, but the example embodiments are not limited thereto.

Additionally, the RAN nodes 110, 120, etc. may be configured to operate in a multi-user (MU) multiple input multiple out (MIMO) mode and/or a massive MIMO (mMIMO) mode, wherein the RAN nodes 110, 120, etc. transmit a plurality of beams (e.g., radio channels, datastreams, streams, etc.) in different spatial domains and/or frequency domains using a plurality of antennas (e.g., antenna panels, antenna elements, an antenna array, etc.) and beamforming and/or beamsteering techniques. For example, RAN nodes 110 and/or 120 may each transmit and/or receive transmissions using two or more beams, but the example embodiments are not limited thereto, and for example, one or more of the RAN nodes may transmit using a greater or lesser number of beams, etc.

Additionally, UE device 120 may be located within the cell service areas 110A and 120A of both the RAN nodes 110 and 120, etc., and may connect to, receive broadcast messages from, receive paging messages from, receive/transmit signaling messages from/to, and/or access the wireless network through, etc., from one or both of the RAN nodes 110 and 120, or in other words, the UE device 120 may perform carrier aggregation using one or more component carriers (CCs) from one or more of the RAN nodes 110 and 120, etc., but the example embodiments are not limited thereto. For example, the UE device 120 may perform carrier aggregation using one or more CCs from both RAN nodes 110 and 120, or may perform carrier aggregation using two or more CCs from a single RAN node (e.g., RAN node 110 or RAN node 120), etc., but the example embodiments are not limited thereto.

According to at least one example embodiment, the UE device 130, etc., may include multiple antenna panels (e.g., may be a multi-panel UE device, etc.), and may transmit and/or receive to a plurality of RAN nodes (e.g., TRPs), such as RAN nodes 110 and 120, etc., using the same time-frequency resources and/or using resources overlapping in time, but the example embodiments are not limited thereto. For example, the UE device 130 may perform semi-static codebook HARQ AN reporting and/or dynamic HARQ AN reporting based on transmission configuration (e.g., TX configuration information, a set of AN offset values, a set of K1 values, etc.) received from a serving RAN node, e.g., which is assumed to be RAN node 110 as an example, and/or the core network 100, etc., wherein the transmission configuration indicates which type of HARQ AN reporting to perform and/or which set of AN offset values to perform, but the example embodiments are not limited thereto. According to at least one example embodiment, the TX confirmation may be transmitted from the serving RAN node 110 to the UE device 130 via radio resource control (RRC) configuration and/or using downlink control information (DCI) in a physical downlink control channel (PDCCH), but the example embodiments are not limited thereto. Detailed discussion of the generation of the set of K1 values and the plurality of subsets of K1 values according to at least one example embodiment which will be discussed in further detail in connection with FIG. 7B.

According to at least one example embodiment, the RAN nodes 110, 120, etc., may be connected to at least one core network element (not shown) residing on the core network 100, such as a core network device, a core network server, access points, switches, routers, nodes, etc., but the example embodiments are not limited thereto. The core network 100 may provide network functions, such as an access and mobility management function (AMF), a session management function (SMF), a policy control function (PCF), a unified data management (UDM), a user plane function (UPF), an authentication server function (AUSF), an application function (AF), and/or a network slice selection function (NSSF), etc., and/or equivalent functions, but the example embodiments are not limited thereto.

While certain components of a wireless communication network are shown as part of the wireless communication system of FIG. 1, the example embodiments are not limited thereto, and the wireless communication network may include components other than that shown in FIG. 1, which are desired, necessary, and/or beneficial for operation of the underlying networks within the wireless communication system, such as access points, switches, routers, nodes, servers, gateways, etc.

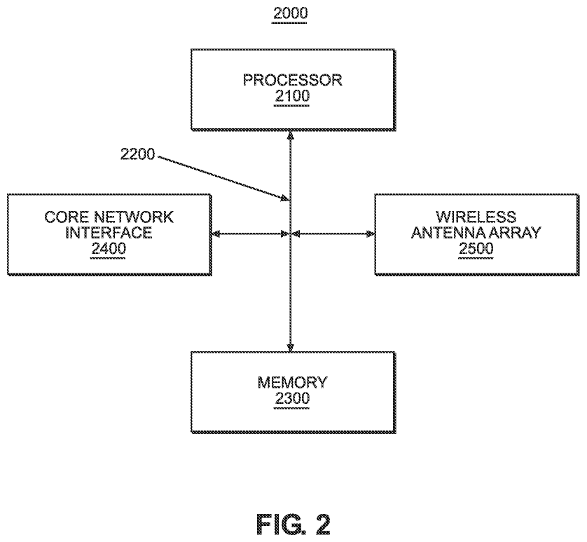

FIG. 2 illustrates a block diagram of an example RAN node according to at least one example embodiment. The RAN node of FIG. 2 may correspond to the RAN nodes 110 and 120 of FIG. 1, but the example embodiments are not limited thereto.

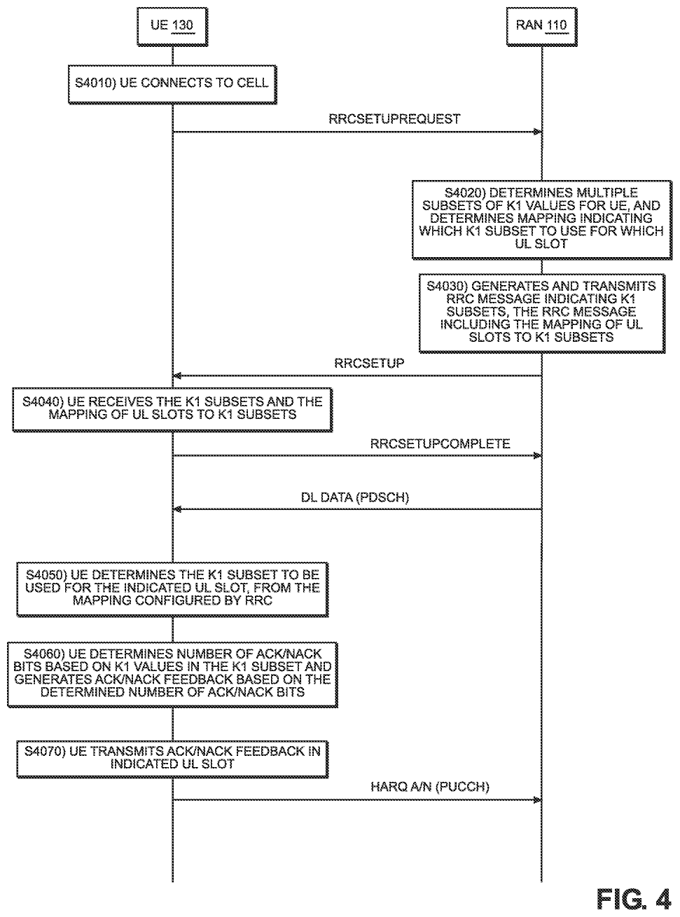

Referring to FIG. 2, a RAN node 2000 may include processing circuitry, such as at least one processor 2100, at least one communication bus 2200, a memory 2300, at least one core network interface 2400, and/or at least one wireless antenna array 2500, etc., but the example embodiments are not limited thereto. For example, the core network interface 2400 and the wireless antenna array 2500 may be combined into a single network interface, etc., or the RAN node 2000 may include a plurality of wireless antenna arrays, a plurality of core network interfaces, etc., and/or any combinations thereof. The memory 2300 may include various special purpose program code including computer executable instructions for performing the operations of FIGS. 4 to 6, etc., which may cause the RAN node 2000 to perform the one or more of the methods of the example embodiments, but the example embodiments are not limited thereto.

In at least one example embodiment, the processing circuitry may include at least one processor (and/or processor cores, distributed processors, networked processors, etc.), such as the at least one processor 2100, which may be configured to control one or more elements of the RAN node 2000, and thereby cause the RAN node 2000 to perform various operations. The processing circuitry (e.g., the at least one processor 2100, etc.) is configured to execute processes by retrieving program code (e.g., computer readable instructions) and data from the memory 2300 to process them, thereby executing special purpose control and functions of the entire RAN node 2000. Once the special purpose program instructions are loaded into, (e.g., the at least one processor 2100, etc.), the at least one processor 2100 executes the special purpose program instructions, thereby transforming the at least one processor 2100 into a special purpose processor.

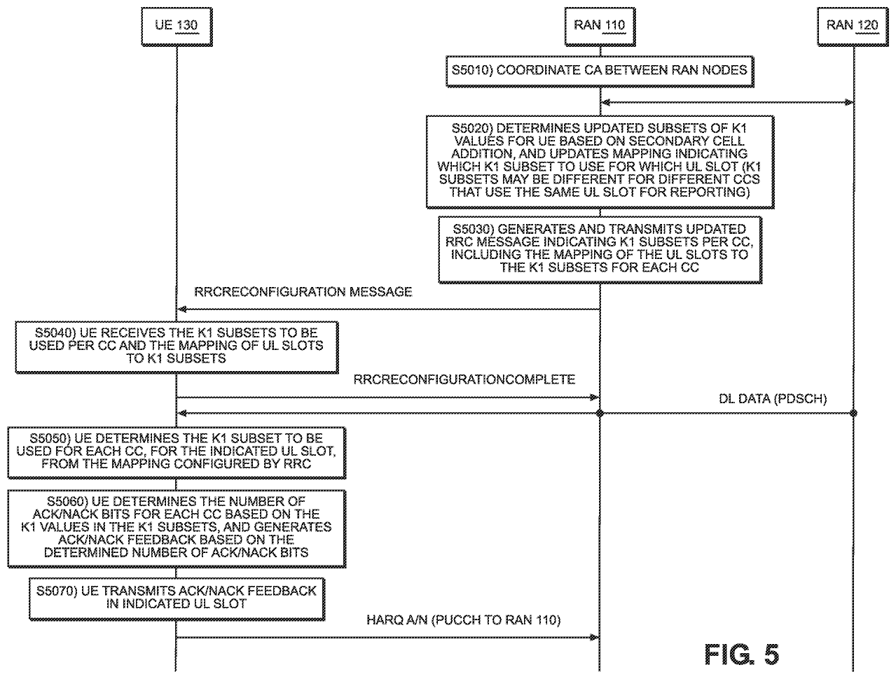

In at least one example embodiment, the memory 2300 may be a non-transitory computer-readable storage medium and may include a random access memory (RAM), a read only memory (ROM), and/or a permanent mass storage device such as a disk drive, or a solid state drive. Stored in the memory 2300 is program code (i.e., computer readable instructions) related to operating the RAN node 2000, such as the methods discussed in connection with FIGS. 4 to 5, the at least one core network interface 2400, and/or at least one wireless antenna array 2500, etc. Such software elements may be loaded from a non-transitory computer-readable storage medium independent of the memory 2300, using a drive mechanism (not shown) connected to the RAN node 2000, or via the at least one core network interface 2400, and/or at least one wireless antenna array 2500, etc.

In at least one example embodiment, the communication bus 2200 may enable communication and data transmission to be performed between elements of the RAN node 2000. The bus 2200 may be implemented using a high-speed serial bus, a parallel bus, and/or any other appropriate communication technology. According to at least one example embodiment, the RAN node 2000 may include a plurality of communication buses (not shown), such as an address bus, a data bus, etc.

The RAN node 2000 may operate as, for example, a 4G RAN node, a 5G RAN node, etc., and may be configured to schedule time domain resource allocations (TDRAs), e.g., orthogonal frequency division multiplexing (OFDM) symbols, physical resource blocks (PRBs), resource elements, etc., for UE devices connected to the RAN node 2000, but the example embodiments are not limited thereto.

For example, the RAN node 2000 may allocate time-frequency resources (e.g., component carriers) of a carrier (e.g., resource blocks with time and frequency dimensions) based on operation on the time domain (e.g., time division duplexing) and/or the frequency domain (e.g., frequency division duplexing). In the time domain context, the RAN node 2000 will allocate a carrier (or subbands of the carrier) to one or more UEs (e.g., UE 120, etc.) connected to the RAN node 2000 during designated upload (e.g., uplink (UL)) time periods and designated download (e.g., downlink (DL)) time periods, or during designated special(S) time periods which may be used for UL and/or DL, but the example embodiments are not limited thereto.

When there are multiple UEs connected to the RAN node 2000, the carrier is shared in time such that each UE is scheduled by the RAN node 2000, and the RAN node 2000 allocates each UE with their own uplink time and/or downlink time. In the frequency domain context and/or when performing spatial domain multiplexing of UEs (e.g., MU MIMO, etc.), the RAN node 2000 will allocate separate frequency subbands (e.g., component carriers) of the carrier to UEs simultaneously served by the RAN node 2000, for uplink and/or downlink transmissions. Data transmission between the UE and the RAN node 2000 may occur on a radio frame basis in both the time domain and frequency domain contexts. The minimum resource unit for allocation and/or assignment by the RAN node 2000 to a particular UE device corresponds to a specific downlink/uplink time interval (e.g., one OFDM symbol, one slot, one minislot, one subframe, etc.) and/or a specific downlink/uplink resource block (e.g., twelve adjacent subcarriers, a frequency subband, etc.). The RAN node 2000 may schedule and/or assign different transmission frame formats, typically for TDD systems, but not limited thereto, wherein each frame format contains a desired succession of DL, S, and/or UL slots in a desired pattern and/or sequence. However, when a UE, such as UE 130, is configured (by the core network 100 and/or the RAN node 2000, etc.) to employ carrier aggregation, the UE 130 may simultaneously transmit/receive data from multiple component carriers (CCs), etc. In this case, the UE 130 will report ack/nack for DL transmissions on all of its activated CCs to the core network 100 and/or the RAN node 2000, etc. For the sake of clarity and consistency, the example embodiments will primarily be described as using the time domain, but the example embodiments are not limited thereto.

Additionally, the RAN node 2000 may transmit scheduling information via physical downlink common channel (PDCCH) information to the one or more UE devices located within the cell servicing area of the RAN node 2000, which may configure the one or more UE devices to transmit (e.g., UL transmissions via physical uplink control channel (PUCCH) information and/or physical uplink shared channel information (PUSCH), etc.) and/or receive (e.g., DL transmissions via PDCCH and/or physical downlink shared channel information (PDSCH), etc.) data packets to and/or from the RAN node 2000. Additionally, the RAN node 2000 may transmit control messages to the UE device using downlink control information (DCI) messages via physical (PHY) layer signaling, medium access control (MAC) layer control element (CE) signaling, radio resource control (RRC) signaling, etc., but the example embodiments are not limited thereto.

According to at least one example embodiment, upon a connection request transmitted by at least one UE device, such as the UE device 130, the RAN node 2000 may also determine whether to use a semi-static codebook or a dynamic codebook for HARQ AN reporting. Assuming that the RAN node 2000 determines to use semi-static codebook, the RAN node 2000 may determine and/or configure a set of K1 values (e.g., a set of AN offset values, etc.) for the UE device 130, the set of K1 values indicating the universe of potential K1 values to be used with for uploading the AN indications (e.g., AN bits, etc.) in desired UL slot(s) of the transmission frame. Further, according to at least one example embodiment, the RAN node 2000 may determine one or more subsets of K1 values (e.g., subsets of AN offset values, etc.) for use with one or more UL slots of the transmission frame from the determined set of K1 values. For example, as shown in FIG. 7B, assuming that the RAN node 2000 schedules a transmission frame including 10 total slots, with slots 0 to 6 being DL slots, slot 7 being a S slot, and slots 8 to 9 being UL slots, the RAN node 2000 may determine and/or calculate the set of K1 values to be, e.g., {4, 5, 6, 7, 8, 11, and 12}, but the example embodiments are not limited thereto, and for example, the transmission frame may have a different number of and/or ordering of DL slots, S slots, and/or UL slots, etc., and/or the number of and/or values of the set of K1 values may be different, etc.

Additionally, the RAN node 2000 may determine and/or assign a first subset of the DL slots and/or the S slot to the first UL slot, e.g., slot 8, and assign a second subset of the DL slots and/or the S slot to the second UL slot, e.g., slot 9, however the example embodiments are not limited thereto, and for example, all of the DL slots and the S slot may be assigned to be reported in a single UL slot, etc. The RAN node 2000 may then configure, determine, and/or map the subsets of the K1 values to one or more UL slots of the transmission frame. For example, if both of the UL slots of the transmission frame are used for AN reporting, a first subset of K1 values (e.g., subset 0) may be, e.g., subset 0={7, 8, 11, and 12}, and a second subset of K1 values (e.g., subset 1) may be, e.g., subset 1={4, 5, 6, and 7}, etc., and the RAN node 2000 may, for example, map the first subset (e.g., subset 0) to the first UL slot (e.g., slot 8), and map the second subset (e.g., subset 1) to the second UL slot (e.g., slot 9), but the example embodiments are not limited thereto. The RAN node 2000 may transmit, provide, and/or configure the K1 set (e.g., the entire K1 set), the first subset of K1 values, and the second subset of K1 values to the UE device 130 using RRC configuration, but the example embodiments are not limited thereto. Additionally, the RAN node 110 may transmit a mapping indicating which subset of K1 values is assigned to which UL slot of the transmission frame via RRC configuration, etc.

According to at least one example embodiment, in the event that the UE device 130 is configured to use carrier aggregation, the RAN node 2000 may determine and/or assign the plurality of K1 subsets on a per-component-carrier (per-CC) basis, e.g., determine and/or assign different subsets (or the same subsets) of K1 subsets for each CC, etc., but the example embodiments are not limited thereto. For example, if the UE device 130 is configured to use a first CC and a second CC, and assuming the transmission frame for both CCs use the same example transmission frame as discussed above, the RAN node 2000 may transmit a mapping to the UE device 130 indicating that a first K1 subset is mapped to the first UL slot for the first CC, a second K1 subset is mapped to the second UL slot for the first CC, a third K1 subset is mapped to the first UL slot for the second CC, and a fourth K1 subset is mapped to the second UL slot for the second CC, etc., but the example embodiments are not limited thereto. Additionally, according to some example embodiments, two or more of the different CCs may be assigned to and/or associated with the same plurality of K1 subsets, particularly if the CCs use the same numerology and the same transmission frame structure, etc., or they may be assigned a different plurality of K1 subsets, e.g., if the CCs use different numerologies and/or different frame structures, etc., but the example embodiments are not limited thereto.

In at least one example embodiment, instead of transmitting the K1 subset mappings using RRC, the RAN node 2000 may indicate an index value corresponding to and/or identifying the K1 subset mapped to a UL slot at the time of DL grant using DCI, etc., but is not limited thereto. According to this at least one example embodiment, the RAN node 2000 may dynamically change the K1 subset mapped to one or more of the UL slots of the transmission frame, thereby further improving the semi-static codebook implementation of one or more of the example embodiments.

The RAN node 2000 may also include at least one core network interface 2400, and/or at least one wireless antenna array 2500, etc. The at least one wireless antenna array 2500 may include an associated array of radio units (not shown) and may be used to transmit the wireless signals in accordance with a radio access technology, such as 4G LTE wireless signals, 5G NR wireless signals, etc., to at least one UE device, such as UE 130, etc. According to some example embodiments, the wireless antenna array 2500 may be a single antenna, or may be a plurality of antennas, etc. For example, the wireless antenna array 2500 may be configured as a grid of beams (GoB) which transmits a plurality of beams in different directions, angles, frequencies, and/or with different delays, etc., but the example embodiments are not limited thereto.

The RAN node 2000 may communicate with a core network (e.g., backend network, backhaul network, backbone network, Data Network, etc.) of the wireless communication network via a core network interface 2400. The core network interface 2400 may be a wired and/or wireless network interface and may enable the RAN node 2000 to communicate and/or transmit data to and from to network devices on the backend network, such as a core network gateway (not shown), a Data Network (e.g., Data Network 105), such as the Internet, intranets, wide area networks, telephone networks, VoIP networks, etc. Detailed discussion of the generation of the set of K1 values and the plurality of subsets of K1 values will be discussed in further detail in connection with FIG. 7B.

While FIG. 2 depicts an example embodiment of a RAN node 2000, the RAN node is not limited thereto, and may include additional and/or alternative architectures that may be suitable for the purposes demonstrated. For example, the functionality of the RAN node 2000 may be divided among a plurality of physical, logical, and/or virtual network elements, such as a centralized unit (CU), a distributed unit (DU), a remote radio head (RRH), and/or a remote radio unit (RRU), etc. Additionally, the RAN node 2000 may operate in standalone (SA) mode and/or non-standalone (NSA) mode using interfaces (not shown) such as X2, Xn, etc., between the RAN node 2000 and other RAN nodes of the wireless network, interfaces, such as S1, NG, etc., between the RAN node 2000 and the core network (e.g., core network 100), interfaces between network functions of the RAN node 2000 operating in a distributed and/or virtual RAN mode (not shown), such as F1, E1, etc., and/or interfaces between the physical layer (e.g., a baseband unit, etc.) and the radio layer (e.g., a RRH, core network interface 2400, etc.) (not shown), such as CPRI, eCPRI, etc., but the example embodiments are not limited thereto.

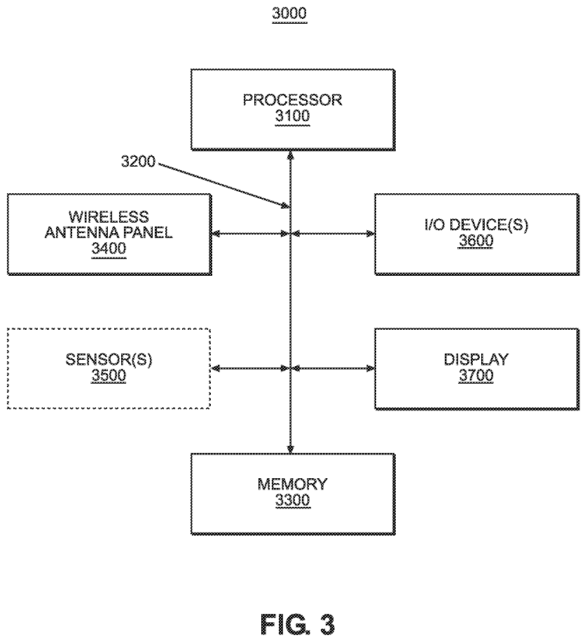

FIG. 3 illustrates a block diagram of an example UE device according to at least one example embodiment. The example UE device 3000 of FIG. 3 may correspond to the UE device 130 of FIG. 1, but the example embodiments are not limited thereto, and the UE device(s) may employ alternative architectures, etc.

Referring to FIG. 3, a UE 3000 may include processing circuitry, such as at least one processor 3100, at least one communication bus 3200, a memory 3300, a plurality of wireless antennas and/or wireless antenna panels 3400, at least one input/output (I/O) device 3600 (e.g., a keyboard, a touchscreen, a mouse, a microphone, a camera, a speaker, etc.), and/or a display panel 3700 (e.g., a monitor, a touchscreen, etc.), but the example embodiments are not limited thereto. According to some example embodiments, the UE 3000 may include a greater or lesser number of constituent components, and for example, the UE 3000 may also include at least one battery (not shown), etc., but the example embodiments are not limited thereto. Additionally, the UE 3000 may further include one or more proximity sensors 3500 (e.g., an infra-red proximity sensor, a capacitive proximity sensor, etc.), one or more location sensors (e.g., GPS, GLONASS, Beidou, Galileo, etc.), other sensors (e.g., thermometers, humidity sensors, pressure sensors, motion sensors, accelerometers, etc.), actuators, etc. Additionally, the display panel 3700, and/or I/O device 3600, etc., of UE 3000 may be optional.

In at least one example embodiment, the processing circuitry may include at least one processor (and/or processor cores, distributed processors, networked processors, etc.), such as the at least one processor 3100, which may be configured to control one or more elements of the UE 3000, and thereby cause the UE 3000 to perform various operations. The processing circuitry (e.g., the at least one processor 3100, etc.) is configured to execute processes by retrieving program code (e.g., computer readable instructions) and data from the memory 3300 to process them, thereby executing special purpose control and functions of the entire UE 3000. Once the special purpose program instructions are loaded into the processing circuitry (e.g., the at least one processor 3100, etc.), the at least one processor 3100 executes the special purpose program instructions, thereby transforming the at least one processor 3100 into a special purpose processor.

In at least one example embodiment, the memory 3300 may be a non-transitory computer-readable storage medium and may include a random access memory (RAM), a read only memory (ROM), and/or a permanent mass storage device such as a disk drive, or a solid state drive. Stored in the memory 3300 is program code (i.e., computer readable instructions) related to operating the UE 3000, such as the methods discussed in connection with FIGS. 4 to 6, etc. Such software elements may be loaded from a non-transitory computer-readable storage medium independent of the memory 3300, using a drive mechanism (not shown) connected to the UE 3000, or via the plurality of wireless antennas 3400, etc. Additionally, the memory 3300 may store network configuration information, such as system information, resource block scheduling, etc., for communicating with at least one RAN node, e.g., RAN nodes 110, 120, etc., accessing a wireless network, etc., but the example embodiments are not limited thereto.

In at least one example embodiment, the at least one communication bus 3200 may enable communication and data transmission/reception to be performed between elements of the UE 3000, and/or monitor the status of the elements of the UE 3000 (e.g., monitor the transmission power levels, monitor the interference levels, monitor channel quality levels, etc.). The bus 3200 may be implemented using a high-speed serial bus, a parallel bus, and/or any other appropriate communication technology. According to at least one example embodiment, the UE 3000 may include a plurality of communication buses (not shown), such as an address bus, a data bus, etc.

The UE 3000 may also include a plurality of wireless antenna panels 3400, but is not limited thereto. The plurality of wireless antenna panels 3400 may include a plurality of associated radio units (not shown) and may be used to transmit wireless signals in accordance with at least one desired radio access technology, such as 4G LTE, 5G NR, Wi-Fi, etc. Additionally, the plurality of wireless antenna panels 3400 may be configured to transmit and/or receive data communications to one or more RAN nodes (e.g., RAN nodes 110, 120, etc.), but the example embodiments are not limited thereto. The plurality of wireless antenna panels 3400 may be located at the same or different physical locations on the body of the UE 3000, may have the same or different orientations, may operate in the same or different frequency ranges, may operate in accordance with the same or different radio access technology, etc. According to some example embodiments, the plurality of wireless antenna panels 3400 may be a single antenna, or may be a plurality of antennas, etc.

While FIG. 3 depicts an example embodiment of a UE 3000, the UE device is not limited thereto, and may include additional and/or alternative architectures that may be suitable for the purposes demonstrated.

FIG. 4 illustrates a first transmission flowchart for configuring a UE device with a plurality of K1 subset values via RRC for single-carrier operation according to at least one example embodiment. Additionally, FIG. 7B is an example diagram illustrating a set of AN offset values and a plurality of subsets of AN offset values according to at least one example embodiment.

Referring now to FIGS. 4 and 7B, according to at least one example embodiment, in operation S4010, a UE device, such as UE 130 of FIG. 1, etc., may connect to a cell served by at least one RAN node, such as RAN node 110 of FIG. 1, etc., e.g., by transmitting a RRCSetupRequest message, etc., but the example embodiments are not limited thereto. In response to the cell connection from the UE 130, in operation S4020, the RAN node 110 may determine whether the UE 130 is to use a semi-static codebook or a dynamic codebook for HARQ AN reporting. If the RAN node 110 determines that a semi-static codebook is to be used by the UE 130, the RAN node 110 may determine a set of K1 values for the UE 130 (e.g., a universe of K1 values, a total set of K1 values, a set of AN offset values, etc.), as well as determine a plurality of subsets of K1 values (e.g., a plurality of subsets of AN offset values, etc.) based on the determined set of K1values, etc. According to at least one example embodiment, the RAN node 110 may determine the plurality of K1 subsets based on the cell type and/or the numerology of at least one desired transmission frame, but the example embodiments are not limited thereto. According to various example embodiments, the RAN node 110 may make the determination of whether to use semi-static codebook, and may make the determination of the set of K1 values, the plurality of K1 subsets, and/or the mapping of K1 subsets to UL slots, either during the RRC connection setup, after the RRC connection setup is complete and after the capabilities of the UE 130 are known, and/or at any other time, but the example embodiments are not limited thereto. Additionally, according to some example embodiments, the RAN node 110 may update the determination of the set of K1 values, the plurality of K1 subsets, and/or the mapping of K1 subsets to UL slots, etc., after an initial determination of one or more of these values based on commands from the core network 100 and/or the network operator, changes in network resource usage, changes in the requirements of the UE 130, changes in the requirements of the RAN node 110, and/or on a periodic basis, etc., but the example embodiments are not limited thereto.

In operation S4030, the RAN node 110 may generate a message (e.g., a RRCSetup message, etc.) including and/or indicating the determined plurality of subsets of K1 values, etc. Additionally, the message may further include a mapping of the one or more UL slots to a particular K1 subset of the plurality of K1 subsets, etc., but the example embodiments are not limited thereto. Moreover, the RAN node 110 may transmit the generated message to the UE 130, etc.

In operation S4040, the UE 130 receives and/or is configured with the plurality of K1 subsets and the mapping of UL slot(s) to K1 subsets and transmits a responsive message (e.g., a RRCSetupcomplete message, etc.). Additionally, the RAN node 110 may transmit DL data via physical downlink shared channel (PDSCH) from the network (e.g., core network 100 and/or data network 105, etc.) to the UE 130 in accordance with the desired transmission frame. In operation S4050, the UE 130 may determine a K1 subset of the plurality of K1 subsets to use with at least one UL slot of the desired transmission frame based on the mapping received from the RAN node 110 (e.g., the mapping configured by RRC, etc.), but the example embodiments are not limited thereto. In operation S4060, the UE 130 may determine the number and/or sequencing of ACK and NACK bits to report in the at least one UL slot based on the K1 values (e.g., AN offset values) included in the determined K1 subset mapped to the at least one UL slot, but is not limited thereto. Additionally, the UE 130 may generate the AN indications (e.g., the ACK or NACK feedback, AN reporting bits, etc.) based on the determined number and/or sequencing of AN bits and the status of the reception of data in the corresponding DL or S slots in the at least one desired transmission frame. For example, the UE 130 may report the ACK or NACK of data during DL or S slots for a current transmission and/or a previous transmission frame, but the example embodiments are not limited thereto. In operation S4070, the UE 130 may transmit the generated AN indications (e.g., AN feedback, AN bits, etc.) to the RAN node 110 in the indicated UL slot via, for example, PUCCH, etc.

Referring now to FIG. 7B, a specific example of the set of K1 values and the plurality of subsets of K1 values will be discussed, but the example embodiments are not limited thereto. As shown in FIG. 7B, a desired transmission frame is assumed to be 10 slots long, with slots 0 to 6 being DL slots, slot 7 being a S slot, and slots 8 to 9 being UL slots, but the example embodiments are not limited thereto. Additionally, it is assumed that the RAN node 110 configures the UE device 130 with the desired set of K1 values of K1 = {4, 5, 6, 7, 8, 11, and 12}, as shown in FIG. 7B, and it is assumed that the RAN node 110 configures the UE device 130 with two subsets of K1 values (e.g., subsets of AN offset values, etc.), Subset 0: K1={7, 8, 11, and 12} and Subset 1: K1={4, 5, 6, and 7}, wherein each of the K1 values indicates a DL or S slot on which to report ACK/NACK, and the K1 value is an offset from the assigned UL slot which corresponds to particular DL or S slot. For example, as shown in FIG. 7B, Subset 0 may be mapped to the first UL slot, e.g., slot 8, and Subset 1 may be mapped to the second UL slot, e.g., slot 9, etc., but the example embodiments are not limited thereto. Accordingly, in the first UL slot, the UE 130 reports an ACK or NACK bit for slot 1 of the current transmission frame (e.g., UL slot 8−offset value 7=slot 1 of the current frame), for slot 0 of the current transmission frame (e.g., UL slot 8−offset value 8=slot 0 of the current frame), for slot 7 of the previous transmission frame (e.g., UL slot 8−offset value 11=slot 7 of the previous frame), and for slot 6 of the previous transmission frame (e.g., UL slot 8−offset value 12=slot 6 of the previous frame) based on the K1 values in Subset 0. Similarly, in the second UL slot, the UE 130 reports an ACK or NACK bit for slot 5 of the current transmission frame (e.g., UL slot 9−offset value 4=slot 5 of the current frame), for slot 4 of the current transmission frame (e.g., UL slot 9−offset value 5=slot 4 of the current frame), for slot 3 of the current transmission frame (e.g., UL slot 9−offset value 6=slot 3 of the current frame), and slot 2 of the current transmission frame (e.g., UL slot 9−offset value 7=slot 2 of the current frame) based on the K1 values in Subset 1. In other words, the UE 130 is configured to report the successful reception of data (ACK) or unsuccessful reception of data, or no data being transmitted by the RAN node 110, (NACK) of each DL slot and S slot in at least one UL slot in one or more desired transmission frames based on the subset of K1 values mapped to the at least one UL slot. So, this configuration avoids reporting of any unnecessary NACK bits by the UE in the UL slots.

While FIG. 7B shows that the number of UL slots in the desired transmission frame is the same as the number of subsets of K1 values determined by the RAN node 110, and that the number of K1 values (e.g., AN offset values) is evenly divided between the first and second subsets of K1 values, the example embodiments are not limited thereto, and for example, the RAN node 120 may determine and/or generate a greater number of subsets of K1 values than UL slots in the desired transmission frame, and/or the number of K1 values included in one of the subsets may be different from the number of K1 values included in other subsets, etc. Moreover, in some example embodiments, individual K1 values of the desired transmission frame may be assigned to multiple subsets of K1 values, etc.

Referring now to FIG. 5, FIG. 5 illustrates a second transmission flowchart for configuring a UE device with a plurality of K1 subset values via RRC for carrier aggregation operation according to at least one example embodiment. FIG. 5 assumes that the UE 130 has previously connected to the serving RAN node 110 and has been configured with a set of K1 values and a plurality of K1 values as shown in FIG. 4, for example, but the example embodiments are not limited thereto. In other example embodiments, the coordination of carrier aggregation (CA) and the assignment of the set of K1 values and plurality of subsets of K1 values corresponding to the plurality of component carriers may occur simultaneously, etc.

In operation S5010, a serving RAN node 110 (e.g., a primary RAN node, a primary cell, etc.) may coordinate carrier aggregation of two or more component carriers for the UE 130 with at least one secondary RAN node 120 (e.g., a secondary cell, etc.), but the example embodiments are not limited thereto. For example, in some example embodiments, carrier aggregation may be performed by a single RAN node using two or more component carriers (CCs), e.g., two or more TDD CCs, two or more FDD CCs, and/or at least one TDD CC and at least one FDD CC, etc. In operation S5020, the serving RAN node 110 may determine updated plurality of subsets of K1 values from a previously determined set of K1 values based on the addition of the secondary cell (and/or determine a set of K1 values and determine subsets of K1 values from the set of K1 values). Additionally, the serving RAN node 110 may update mapping information indicating which K1 subset of the plurality of K1 subsets is used for which UL slot of the at least one desired transmission frame for each CC assigned to the UE 130. In at least one example embodiment, the serving RAN node 110 may determine different groups of K1 subsets for each CC assigned to the UE 130, and in other example embodiments, the serving RAN node 110 may use the same group of K1 subsets for two or more of the CCs assigned to the UE 130, etc.

In operation S5030, the serving RAN node 110 may generate a message (e.g., a RRC message, etc.) to the UE 130, the message including the K1 set and the list of K1 subsets per CC, but the example embodiments are not limited thereto. Additionally, the message may further include the mapping of UL slots of the at least one transmission frame to the K1 subsets for each CC, etc. Moreover, the serving RAN node 110 may transmit the generated message to the UE 130 (e.g., via a RRCReconfiguration message, etc.), but the example embodiments are not limited thereto.

In operation S5040, the UE 130 may receive the message including the K1 set, the K1 subsets, and/or the mapping information, and transmit a responsive message, such as a RRCReconfigurationComplete message, etc., to the serving RAN node 110, etc. Additionally, the serving RAN node 110 and the secondary RAN node 120 may transmit data in the DL and/or S slots via PDSCH to the UE 130 in accordance with the desired transmission frame.

In operation S5050, similar to operation S4050 of FIG. 4, the UE 130 may determine the K1 subset to be used for the indicated at least one UL slot for each CC based on the mapping information received from the serving RAN node 110 (e.g., configured by RRC, etc.). In operation S5060, similar to operation S4060 of FIG. 4, the UE 130 may determine the number and sequencing of ACK and NACK bits for each CC based on the K1 values in the K1 subsets, and may generate the AN feedback based on the determined number and/or sequencing of ACK and NACK bits, etc. In operation S5070, the UE 130 may transmit the ACK/NACK feedback in the appropriate UL slot for each CC via PUCCH, etc., but the example embodiments are not limited thereto. In some example embodiments, the ack/nack feedback for all DL transmissions of all CCs may be sent in a UL slot on PUCCH of the primary cell (PCell) of the UE 130, but the example embodiments are not limited thereto. In other example embodiments, the ack/nack feedback for some CCs may be sent in a UL slot on a PUCCH of one cell, e.g., the primary cell, etc., and for other CCs may be sent in a UL slot on a PUCCH of a different cell, e.g., a secondary cell (SCell), etc. In yet other embodiments, the ack/nack feedback may be sent in a UL slot on a PUSCH of either the PCell of the UE 130 or PUSCH of the different cell, e.g., SCell, etc.

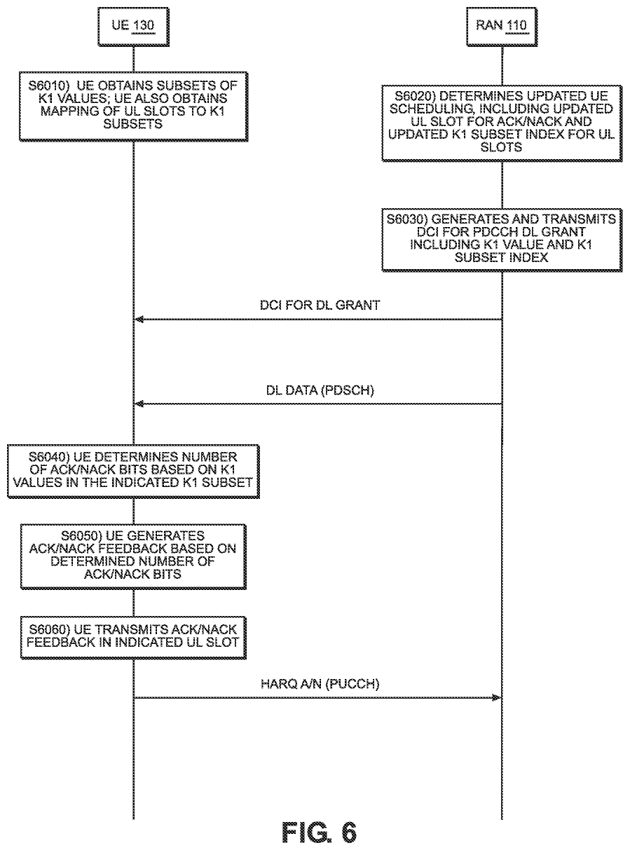

Referring now to FIG. 6, FIG. 6 illustrates a third transmission flowchart for configuring a UE device with a plurality of K1 subset values via DCI for single-carrier operation according to at least one example embodiment. In operation S6010, the UE 130 may obtain the set of K1 values, the plurality of subsets of K1 values, and/or the mapping of UL slots of K1 subsets. For example, the UE 130 may obtain the set of K1 values, the plurality of subsets of K1 values, and/or the mapping information via the methods discussed in FIGS. 4 and 5, e.g., via RRC, but the example embodiments are not limited thereto. In operation S6020, the RAN node 110 may receive DL data for the UE 130 in its buffer, and may determine an updated transmission scheduling for the UE 130 based on the received DL data, but is not limited thereto. For example, the RAN node 110 may modify and/or change the number and/or sequencing of DL, UL, and/or S slots in the desired transmission frame, but is not limited thereto. Additionally, the RAN node 110 may determine one or more updated UL slots for reporting ACK/NACK, and may determine updated mapping information indicating updated mappings of K1 subsets from the previously determined set of K1 values (in operation S6010) for each of the at least one UL slots for reporting AN, etc. In operation S6030, the RAN node 110 may generate DCI for PDCCH DL grant, the DCI including the updated mapping of UL slots to K1 subsets, etc. Additionally, the RAN node 110 may transmit the DCI to the UE 130 as part of the DL grant to the UE 130, etc. In operation, the RAN node 110 may transmit data in the DL slots of the updated scheduling via PDSCH, but the example embodiments are not limited thereto.

In operation S6040, the UE 130 may determine the number and/or sequencing of ACK and NACK bits based on the K1 values included in the indicated K1 subset for at least one UL slot of the updated transmission frame. In operation S6050, the UE 130 may generate the AN indications (e.g., AN feedback, AN bits, etc.) based on the determined number of AN bits and the status of the reception of data in the corresponding DL or S slots in the at least one desired transmission frame. In operation S6060, the UE 130 may transmit the generated AN indications to the RAN node 110 in the indicated UL slot via, for example, PUCCH, etc.

It is understood that the AN indications that indicate the status of the DL transmissions in various slots on various CCs may be represented in various ways. For example, the UE 130 may use one bit for each DL transmission, e.g., 0 for NACK if the reception/decoding of the corresponding transmission in a DL slot was unsuccessful, and 1 for ACK if the reception/decoding was successful, but the example embodiments are not limited thereto and other forms may be used. For instance, if multiple layers were transmitted in a MIMO system, then the UE 130 may use one bit to represent the status of each layer, or one bit to represent a combined status of all layers, and/or the like. In other examples, the status of one or more transmissions may be indicated together using one bit or more than one bit per transmission, and/or jointly encoding the status of multiple transmissions into a desired and/or certain number of bits, etc. In other cases, instead of binary indications (e.g., ACK or NACK), a more granular indication may be used. For the UE 130 transmission of these bits and/or other forms of indication, the bits may be further encoded and/or modulated into other suitable forms, e.g., using quadrature phase shift keying (QPSK) or binary phase-shift keying (BPSK), etc., with a desired and/or certain coding rate using, e.g., a Reed-Muller code, a Polar code, or the like. Any such form may be used for AN indications without limitation.

The transmission of K1 subsets and the mapping of K1 subsets to UL slots to the device may happen in any suitable form. In one example, an RRC message may be used. In other example embodiments, the information may be sent in a MAC control element in a MAC header, and/or in any suitable format in any suitable protocol message. The RAN node 110 may determine to change the K1 subsets and/or the mapping at any time based on any suitable criteria. Moreover, in some example embodiments, the RAN node 110 may transmit the K1 set to the UE 130 with the plurality of K1 subsets and the mapping of K1 subsets to the UL slots, etc. However, the example embodiments are not limited thereto, and for example, the RAN node 110 may omit transmission of the K1 set and/or configuration of the UE 130 with the K1 set, and the RAN node 110 may only transmit the K1 subsets and the mapping of K1 subsets to the UL slots, etc.

Additionally, in the case of carrier aggregation, the frame formats and numerologies of the component carriers assigned to the UE 130 may be either the same or different. In some example embodiments any of the CCs may be an FDD carrier or a TDD carrier (e.g., the UE 130 is assigned FDD CCs, TDD CCs, and/or FDD and TDD CCs), and/or any carrier type with any form of duplexing/multiplexing between uplink and downlink, etc. The AN indications may be sent by the UE device 130 to the RAN node 110 on the uplink of any carrier, on any channel (e.g. on PUCCH or PUSCH, etc.) without limitation.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1.-30. (canceled)

31. A user equipment (UE) device comprising:
a memory storing computer readable instructions; and
processing circuitry configured to execute the computer readable instructions to cause the device to:
receive, via a radio resource control (RRC) message from the at least one RAN node, a plurality of subsets of acknowledgement/negative acknowledgement (AN) offset values associated with at least one desired transmission frame from at least one radio access network (RAN) node, the desired transmission frame including a plurality of downlink (DL) slot and a plurality of uplink (UL) slots, and wherein the RRC message includes UL slot mapping information associated with at least one subset of the plurality of subsets to the plurality of UL slots, the UL slot mapping information including UL slot mapping information indicating a mapping of each of the plurality of UL slots to a subset of the plurality of subsets;
receive DL data from the at least one RAN node in the plurality of DL slots of the desired transmission frame;
determine a number of AN bits to transmit to the at least one RAN node for at least one UL slot of the desired transmission frame based on the plurality of subsets of AN offset values;
determine which DL slot of the plurality of DL slots maps to the at least one UL slot based on the UL slot mapping information associated with the at least one UL slot;
generate AN indications for the plurality of DL slots based on a status of the received DL data associated with each DL slot of the plurality of DL slots; and
transmit the AN indications to the at least one RAN node in the at least one UL slot based on the received DL data and the determined number of AN bits for the at least one UL slot.

32. The device of claim 31, wherein the device is further caused to:
receive a plurality of updated subsets of AN offset values from the at least one RAN node for the plurality of UL slots of the desired transmission frame, each of the plurality of UL slots corresponding to at least one component carrier (CC) of a plurality of CCs;
receive new DL data from the at least one RAN node in the at least one CC from the at least one RAN node;
determine an updated number of AN bits to transmit to the at least one RAN node for each the plurality of UL slots based on the plurality of updated subsets of AN offset values; and
transmit updated AN indications to the at least one RAN node in the plurality of UL slots based on the received new DL data and the determined updated number of AN bits for the plurality of UL slots.

33. The device of claim 32, wherein the at least one RAN node includes at least a first RAN node and a second RAN node.

34. The device of claim 33, wherein each of the first RAN node and the second RAN node are configured to communicate with the UE device using a different CC of the plurality of CCs.

35. The device of claim 34, wherein the device is further caused to:
receive a first updated subset of AN offset values for each of the plurality of UL slots corresponding to a first CC from the first RAN node.

36. The device of claim 35, wherein the device is further caused to:
receive a second updated subset of AN offset values for each of the plurality of UL slots corresponding to a second CC from the first RAN node.

37. The device of claim 36, wherein the device is further caused to:
receive downlink control information (DCI) for DL grant from the at least one RAN node, the DCI including an indication of the updated subset of AN offset values to be used for a desired UL slot;
receive new DL data from the at least one RAN node in the at least one DL slot of the desired transmission frame;
determine an updated number of AN bits to transmit to the at least one RAN node in the desired UL slot based on the updated subsets of AN offset values; and
transmit updated AN indications to the at least one RAN node in the desired UL slot based on the received new DL data and the determined updated number of AN bits for the desired UL slot.

38. A system comprising:
a user equipment (UE) device comprising:
a memory storing computer readable instructions; and
processing circuitry configured to execute the computer readable instructions to cause the device to:
receive, via a radio resource control (RRC) message from the at least one RAN node, a plurality of subsets of acknowledgement/negative acknowledgement (AN) offset values associated with at least one desired transmission frame from at least one radio access network (RAN) node, the desired transmission frame including a plurality of downlink (DL) slot and a plurality of uplink (UL) slots, and wherein the RRC message includes UL slot mapping information associated with at least one subset of the plurality of subsets to the plurality of UL slots, the UL slot mapping information including UL slot mapping information indicating a mapping of each of the plurality of UL slots to a subset of the plurality of subsets;
receive DL data from the at least one RAN node in the plurality of DL slots of the desired transmission frame;
determine a number of AN bits to transmit to the at least one RAN node for at least one UL slot of the desired transmission frame based on the plurality of subsets of AN offset values;
determine which DL slot of the plurality of DL slots maps to the at least one UL slot based on the UL slot mapping information associated with the at least one UL slot;
generate AN indications for the plurality of DL slots based on a status of the received DL data associated with each DL slot of the plurality of DL slots; and
transmit the AN indications to the at least one RAN node in the at least one UL slot based on the received DL data and the determined number of AN bits for the at least one UL slot.

39. The system of claim 38, wherein the device is further caused to:
receive a plurality of updated subsets of AN offset values from the at least one RAN node for the plurality of UL slots of the desired transmission frame, each of the plurality of UL slots corresponding to at least one component carrier (CC) of a plurality of CCs;
receive new DL data from the at least one RAN node in the at least one CC from the at least one RAN node;
determine an updated number of AN bits to transmit to the at least one RAN node for each the plurality of UL slots based on the plurality of updated subsets of AN offset values; and
transmit updated AN indications to the at least one RAN node in the plurality of UL slots based on the received new DL data and the determined updated number of AN bits for the plurality of UL slots.

40. The system of claim 39, wherein the at least one RAN node includes at least a first RAN node and a second RAN node.

41. The system of claim 40, wherein each of the first RAN node and the second RAN node are configured to communicate with the UE device using a different CC of the plurality of CCs.

42. The system of claim 41, wherein the device is further caused to:
receive a first updated subset of AN offset values for each of the plurality of UL slots corresponding to a first CC from the first RAN node.

43. The system of claim 42, wherein the device is further caused to:
receive a second updated subset of AN offset values for each of the plurality of UL slots corresponding to a second CC from the first RAN node.

44. The system of claim 43, wherein the device is further caused to:
receive downlink control information (DCI) for DL grant from the at least one RAN node, the DCI including an indication of the updated subset of AN offset values to be used for a desired UL slot;
receive new DL data from the at least one RAN node in the at least one DL slot of the desired transmission frame;
determine an updated number of AN bits to transmit to the at least one RAN node in the desired UL slot based on the updated subsets of AN offset values; and
transmit updated AN indications to the at least one RAN node in the desired UL slot based on the received new DL data and the determined updated number of AN bits for the desired UL slot.

45. A method comprising:
receiving, via a radio resource control (RRC) message from the at least one RAN node, a plurality of subsets of acknowledgement/negative acknowledgement (AN) offset values associated with at least one desired transmission frame from at least one radio access network (RAN) node, the desired transmission frame including a plurality of downlink (DL) slot and a plurality of uplink (UL) slots, and wherein the RRC message includes UL slot mapping information associated with at least one subset of the plurality of subsets to the plurality of UL slots, the UL slot mapping information including UL slot mapping information indicating a mapping of each of the plurality of UL slots to a subset of the plurality of subsets;
receiving DL data from the at least one RAN node in the plurality of DL slots of the desired transmission frame;
determining a number of AN bits to transmit to the at least one RAN node for at least one UL slot of the desired transmission frame based on the plurality of subsets of AN offset values;
determining which DL slot of the plurality of DL slots maps to the at least one UL slot based on the UL slot mapping information associated with the at least one UL slot;
generating AN indications for the plurality of DL slots based on a status of the received DL data associated with each DL slot of the plurality of DL slots; and
transmitting the AN indications to the at least one RAN node in the at least one UL slot based on the received DL data and the determined number of AN bits for the at least one UL slot.

46. The method of claim 38, wherein the device is further caused to:
receive a plurality of updated subsets of AN offset values from the at least one RAN node for the plurality of UL slots of the desired transmission frame, each of the plurality of UL slots corresponding to at least one component carrier (CC) of a plurality of CCs;
receive new DL data from the at least one RAN node in the at least one CC from the at least one RAN node;
determine an updated number of AN bits to transmit to the at least one RAN node for each the plurality of UL slots based on the plurality of updated subsets of AN offset values; and
transmit updated AN indications to the at least one RAN node in the plurality of UL slots based on the received new DL data and the determined updated number of AN bits for the plurality of UL slots.

47. The system of claim 39, wherein the at least one RAN node includes at least a first RAN node and a second RAN node.

48. The system of claim 40, wherein each of the first RAN node and the second RAN node are configured to communicate with the UE device using a different CC of the plurality of CCs.

49. The system of claim 41, wherein the device is further caused to:
receive a first updated subset of AN offset values for each of the plurality of UL slots corresponding to a first CC from the first RAN node; and
receive a second updated subset of AN offset values for each of the plurality of UL slots corresponding to a second CC from the first RAN node.

50. The system of claim 43, wherein the device is further caused to:
receive downlink control information (DCI) for DL grant from the at least one RAN node, the DCI including an indication of the updated subset of AN offset values to be used for a desired UL slot;
receive new DL data from the at least one RAN node in the at least one DL slot of the desired transmission frame;
determine an updated number of AN bits to transmit to the at least one RAN node in the desired UL slot based on the updated subsets of AN offset values; and
transmit updated AN indications to the at least one RAN node in the desired UL slot based on the received new DL data and the determined updated number of AN bits for the desired UL slot.
